(19) United States
(12) Patent Application Publication
(10) Pub. No.: US 2015/0246998 A1
(43) Pub. Date: Sep. 3, 2015

(54) TRANSPARENT POLYURETHANES WITH HIGH GLASS TRANSITION TEMPERATURE Tg

(71) Applicant: Bayer MaterialScience AG, Monheim Am Rhein (DE)

(72) Inventors: Mathias Matner, Neuss (DE); Holger Casselmann, Odenthal (DE); Wei Zhuang, Monheim (DE); Dirk Achten, Leverkusen (DE); Michael Ehlers, Krefeld (DE)

(21) Appl. No.: 14/624,761

(22) Filed: Feb. 18, 2015

(30) Foreign Application Priority Data
Feb. 21, 2014 (EP) 14156071.4
Oct. 27, 2014 (EP) 14190394.8

(51) Int. Cl. C08G 18/78; C08G 18/32; G02B 5/02; C08G 18/75; G02B 1/04; C08G 18/73; C08G 18/24

(52) U.S. Cl. CPC C08G 18/7831; C08G 18/73; C08G 18/3206; C08G 18/242; C08G 18/758; G02B 1/041; G02B 5/0278

(57) ABSTRACT

The present invention relates to a polyurethane exclusively composed of a polyisocyanate component and of a polyol component, where the polyisocyanate component consists of one or more polyisocyanates and the average NCO functionality per molecule of the polyisocyanate component is ≧3, and the polyol component consists of one or more polyols and the average OH functionality per molecule of the polyol component is ≧3 and its OH content is ≧25% by weight. The invention further relates to a process for the production of the polyurethane of the invention, to an optical element comprising or consisting of a polyurethane of the invention, and also to the use of a polyurethane of the invention for conducting light, scattering light and/or deflecting

The present invention relates to a transparent polyurethane with high glass transition temperature T_{g}.

Production of optical elements such as optical conductors, optical diffusers or lenses requires materials that are transparent, i.e. have maximum possible permeability to electromagnetic waves in particular in the spectral range that is visible to humans: from 400 to 800 nm. Because many light sources such as incandescent lamps, but also LEDs produce heat concomitantly when they generate light, it is moreover of considerable importance that the optical elements and, respectively, the materials used for production thereof have high thermal stability and mechanical stability. Specifically, this means that by way of example no deformation of the materials is permitted even when they are subjected to significant heating, since otherwise by way of example a lens can become useless. At the same time, they must also have sufficient hardness at normal temperatures to resist mechanical loads,

The increasing use of LEDs as light sources has moreover generated a considerable requirement for novel materials which on the one hand comply with the prevailing requirements and on the other hand are suitable for the encapsulation of or the casting process to encapsulate, LEDs.

It was therefore an object of the present invention to provide a material which is transparent, has high thermal stability and mechanical stability and moreover also is suitable for the encapsulation of light sources such as LEDs.

According to the invention, the said object is achieved via a polyurethane exclusively composed of a polyisocyanate component and of a polyol component, where the polyisocyanate component consists of one or more polyisocyanates and the average NCO functionality per molecule of the polyisocyanate component is ≧3, and the polyol component consists of one or more polyols and the average OH functionality per molecule of the polyol component is ≧3 and its OH content is ≧25% by weight.

Surprisingly, it has been found that polyurethanes of this type have high transparency: they exhibit transmittance values of more than 80% in measurements in accordance with the method described in the experimental section. The polyurethanes of the invention moreover also have unusually high thermal stability. In accordance with the method described in the experimental section, glass transition temperatures determined for the polyurethanes of the invention were above 80° C. They therefore have excellent suitability for the production of optical elements such as optical conductors, optical diffusers or lenses, where these are intended for exposure to elevated temperatures. Shore D hardness values of more than 70 were moreover determined for the polyurethanes of the invention in accordance with the method described in the experimental section, and this provides evidence of the good mechanical stability of the polymers. The polyurethanes of the invention can also easily he used for the encapsulation of light sources such as LEDs.

For the process of the present invention, compounds regarded as polyurethanes are organic compounds which have urethane groups —NH—CO—O—.

A polyisocyanate is an organic compound which has NCO groups.

The NCO functionality of the polyisocyanate component can be calculated by dividing the total number of NCO groups of the polyisocyanates of which the polyisocyanate component consists by the total number of molecules of the polyisocyanate component.

The term polyol present means an organic compound which has OH groups.

The OH functionality of the polyol component can be calculated by dividing the total number of OH groups of the polyols of which the polyol component consists by the total number of molecules of the polyol component.

The OH content is, in percent by weight, the magnitude of the molecular weight content provided by the OH groups, based on the total molecular weight of the polyol component.

A first preferred embodiment provides that the NCO functionality of the polyisocyanate component is ≦4 and/or the OH functionality of the polyol component is 6.

Examples of polyisocyanates suitable according to the invention are any of the organic aliphatic, cycloaliphatic, aromatic or heterocyclic polyisocyanates known to the person skilled in the art. It is particularly preferable that the NCO functionality of all of the polyisocyanates is ≧2.

It is also preferable that the polyisocyanate is an aliphatic compound. It is likewise preferable that the polyisocyanate component consists exclusively of aliphatic polyisocyanates.

Examples of suitable polyisocyanates are the oligomers of aliphatic di- or triisocyanates, for example hexane diisocyanate (hexamethylene diisocyanate, HDI), pentane diisocyanate, butane diisocyanate, methylenebis(cyclohexyl 4,4-isocyanate), 3,5,5-trimethyl-1-isocyanato-3-isocyanatomethylcyclohexane (isophorone diisocyanate, 4-isocyanatomethyloctane 1,8-diisocyanate, 1,3-bis(isocyanatomethyl)benzene (XDI), hydrogenated xylylene diisocyanate, and also hydrogenated toluene diisocyanate.

The adducts of the abovementioned di- and/or triisocyanates are termed oligomers. These can be produced from the addition reaction between isocyanate groups to give uretdiones and/or isocyanurates and/or from reaction products, and downstream products thereof, of isocyanate groups with water and amines, or else with alcohols, where the number of reacted di- or triisocyanates per molecule of oligomer is at least two. The oligomers moreover comprise reactive isocyanate groups. For the purposes of the present invention, the oligomers are moreover defined as compounds having less than 40% by weight, preferably less than 25% by weight, content that has more than 11 reacted di- or triisocyanates per molecule.

The NCO content of the polyisocyanate component can in particular be ≧15% by weight and ≦55% by weight, preferably 18% by weight and 50% by weight and particularly preferably >20% by weight and ≦30% by weight. The NCO content is, in percent by weight, the magnitude of the molecular weight content provided by the NCO groups, based on the total molecular weight of the polyisocyanate component.

According to another preferred embodiment, at least one polyisocyanate is a biuret, a uretdione or an isocyanurate of a di- or triisocyanate. It is preferable here that the di- or triisocyanate is selected from the group of hexane diisocyanate, isophorone diisocyanate, methylenebis(cyclohexyl 4,4′-isocyanate), xylylene diisocyanate, tetramethylxylylene diisocyanate, hydrogenated xylylene diisocyanate, hydrogenated toluene diisocyanate, pentane diisocyanate and 4-isocyanatomethyloctane 1,8-diisocyanate.

It is very particularly preferable to use, as polyisocyanate, an isocyanurate of the di- or triisocyanates. It is still more preferable to use, as polyisocyanate, an isocyanurate of hexane diisocyanate or isophorone diisocyanate or a mixture of isocyanurates thereof

Examples of polyols suitable according to the invention are any of the organic aliphatic, cycloaliphatic, aromatic or heterocyclic polyols known to the person skilled in the art, It is particularly preferable that the OH functionality of all of the polyols is ≧2.

Examples of suitable polyols are 1,2,10-decanetriol, 1,2,8-octanetriol, 1,2,3-trihydroxybenzene, glycerol, 1,1,1,-trimethylolpropane, 1,1,1,-trimethylolethane, pentaerythritol or sugar alcohols.

Particularly preferred polyols are the purely aliphatic compounds glycerol, 1,1,1-trimethylolpropane, 1,1,1-trimethylolethane, pentaerythritol and sugar alcohols.

An embodiment of the invention provides that the OH content of the polyol component is ≧25% by weight and ≦60% by weight, preferably ≧30% by weight and ≧60% by weight and particularly preferably 35% by weight and 60% by weight.

The molecular ratio of polyisocyanate to polyol can be adjusted in such a way that the ratio of the NCO groups to OH groups is in the range from 0.95:1.00 to 120:1.00, preferably in the region of 1.05:1.00 and particularly preferably 1.00:1.00.

The invention further provides a process for the production of a polyurethane of the invention by mixing the polyisocyanate component and the polyol component and optionally adding a catalyst and/or additives and optionally heating the mixture.

The polyisocyanate component and the polyol component can by way of example be mixed with the aid of various static or dynamic mixing assemblies known to the person skilled in the art.

One preferred embodiment of the process of the invention provides that, before the mixing process, the polyisocyanate component and the polyol component are heated to a temperature of from 30 to 90° C., preferably from 35 to 80° C. and particularly preferably from 40 to 60° C.

It is likewise preferable that the quantity of catalyst added, based on sums of the masses of the polyisocyanate component and of the polyol component, is from 0.001 to 0.100% by weight, preferably from 0.002 to 0.050% by weight and particularly preferably from 0.005 to 0.030% by weight.

Examples of suitable catalysts are the typical urethanization catalysts as set out by way of example in Becker/Braun, Kunststoffhandbuch Band 7, Polyurethane [Plastics handbook, Volume 7, Polyurethanes], chapter 3.4. A particular catalyst that can be used is a compound selected from the group of the amines and organylmetal compounds, preferably from the group of the organyltin compounds and of the organylbismuth compounds, and particularly preferably dibutyltin dilaurate.

The catalyst can be added either in a form. diluted with suitable solvents or else undiluted to one of the two components. It is preferable that the catalyst is premixed with one component, without addition of solvent, before the said component is mixed with the other component.

Various additives can be added as further components, examples being flame retardants, dyes, fluorescers, transparent fillers, light stabilizers, antioxidants, agents having thixotropic effect, mould-release agents, adhesion promoters, agents that scatter light, and optionally other auxiliaries and additional substances.

Suitable processes are optionally used to dry and devolatilize the starting materials before mixing, in order to prevent undesired side reactions and formation of bubbles.

It is advantageous in the process of the invention to mix the polyisocyanate component and the polyol component, and also optionally the other components under anhydrous conditions, since small quantities of moisture can lead to formation of bubbles. The residual water content in the mixture should therefore be kept sufficiently small to avoid occurrence of any undesired effects. The water content of the mixture can preferably be ≦0.5% by weight.

The process of the invention can also be carried out with the use of up to 40% by weight of organic solvents, but it is preferable to use no, or only small quantities of, solvents.

The invention still further provides an optical element comprising or consisting of a polyurethane of the invention.

The optical elements of the invention can be produced by various production processes, for example casting, rapid injection moulding (RIM), dip-coating or other coating processes, or other suitable processes.

The optical element can preferably be an optical conductor, an optical diffuser, or a lens.

Examples of the optical elements of the invention can be lenses in automobile headlights, optical correction lenses, optical conductors, LED-encapsulation systems with optionally incorporated fluorescers (usually described as “phosphor” in the industry) or other transparent components.

The invention likewise provides the use of any polyurethane of the invention for conducting light, scattering light and/or deflecting light.

The invention is explained in more detail below with reference to examples.

General Information:

Unless otherwise stated, all percentages are percentage by weight (% by weight).

The ambient temperature prevailing at the time of conduct of the experiments, 23° C., is described as RT (room temperature).

The NCO or OH functionality of the various raw materials was in each case determined by calculation.

Test Methods:

The methods listed below for determining the corresponding parameters were used for the conduct and evaluation of the examples, and are also the general methods for determining the parameters that are relevant according to the invention.

Determination of Transmittance

The transmittance of the hardened polyurethane systems was determined with a Byk-Gardner haze-gard plus device in accordance with the ASTM standard D1003. The measurement was made on samples of thickness 1 cm.

Determination of Glass Transition Temperature

Glass transition temperature (Tg) was determined by using the DMA method on free films with an excitation frequency of 1 Hz.

Determination of Shore Hardness

Shore hardness was tested on membranes of thickness 2 mm made from the hardened polyurethane systems in accordance with DIN 53505.

Starting Materials

Desmodur N 3600 is an HDI trimer (NCO functionality >3) with 23.0% by weight NCO content from Bayer MaterialScience. Viscosity is 1200 mPas (DIN EN ISO 3219/A.3).

Desmodur N 3200 is a low-viscosity HDI biuret (NCO functionality >3) with 23.0% by weight NCO content from Bayer MaterialScience. Viscosity is 2500 mPas (DIN EN ISO 3219/A.3).

Desmodur N 3400 is an HDI uretdione (NCO functionality<3) with 21.8% by weight NCO content from Bayer MaterialScience. Viscosity is 175 mPas (DIN EN ISO 3219/A.3).

Desmodur N 3900 is a low-viscosity aliphatic polvisocyanate resin based on hexamethylene diisocyanate (NCO functionality >3) with 23.5% by weight NCO content from Bayer MaterialScience. Viscosity is 730 mPas (DIN EN ISO 3219/A.3),

Desmodur XP 2489 is an HDI/IPDI trimer (NCO functionality >3) with 21.0% by weight NCO content from Bayer MatcrialScience. Viscosity is 22 500 mPas (DIN EN ISO 3219/A.3).

Glycerol (1,2,3-propanetriol) was purchased with purity 99.0% from Calbiochem.

1,1,1-Trimethylolpropane (IMP) was purchased with purity 97.0% from Aldrich.

Desmophen VP LS 2249/1 is a branched (2<F<3), short-chain polyester polyol from Bayer MaterialScience with 15.5% hydroxyl content.

Desmophen XP 2488 is a branched (2<F<3) polyester polyol from Bayer MaterialScience with 16.0% hydroxyl content.

Desmophen VP LS 2328 is a linear (F =2), short-chain polyester polyol from Bayer MaterialScience with 7.95% hydroxyl content.

Dibutyltin dilaurate (DBTL) was purchased as Tinstab BL277 from Acros Chemicals.

All of the raw materials except the catalyst were devolatilized in vacuo prior to use, and the polyols were also dried.

Production of the Polyurethanes

Unless otherwise stated, the polyurethanes were produced by heating the two components (polyisocyanate and polyol) to 50° C. and mixing them in an NCO:OH ratio of 1.0:1.0, adding the stated quantity of catalyst, and mixing the entire composition at 2750 rpm for 60 seconds in a Speedmixer DAC 150.1 FVZ from Hauschild.

The mixture was then cast into a suitable mould and hardened in an oven. The heating programme used here was as follows: 2 hours at 50° C.+16 hours at 100° C.+2 hours at 150° C. This gave clear, transparent mouldings.

TABLE 1
Inventive Examples

| | Shore D | | |
|---|---|---|---|
| PU system | hardness | Tg | Transmittance |
| Desmodur N 3600, glycerol, | 79 | 103° C. | 91% |
| DBTL (0.01% by weight) | | | |
| Desmodur N 3600, glycerol, | 78 | 84° C. | 90% |
| NCO:OH = 1.2:1; DBTL (0.01% | | | |
| by weight) | | | |
| Desmodur N 3600, TMP, DBTL | 82 | 116° C. | 90% |
| (0.01% by weight) | | | |
| Desmodur N 3600, glycerol, TMP | 74 | 109° C. | 92% |
| (50:50% by weight), DBTL | | | |
| (0.01% by weight) | | | |
| Desmodur XP 2489, glycerol, | 87 | 160° C. | 89% |
| DBTL (0.01% by weight) | | | |
| Desmodur N 3200, glycerol, | 84 | 84° C. | 91% |
| DBTL (0.01% by weight) | | | |
| Desmodur N 3900, glycerol, | 83 | 90° C. | 87% |
| DBTL (0.01% by weight) | | | |

The polyurethanes of the invention listed in Table 1 have high mechanical stability. The Shore D hardness values provide evidence of this, being in each case above 70. However, they moreover also have high thermal stability, which can be seen from the glass transition temperatures determined: >80° C. Finally, transmittance measurement also revealed that the polyurethanes produced are transparent and therefore have particularly good suitability for optical applications.

TABLE 2
Comparative Examples

| | Shore D | | |
|---|---|---|---|
| PU system | hardness | Tg | Transmittance |
| Desmodur N 3400, glycerol, | 73 | 48° C. | n.m. |
| DBTL (0.01% by weight) | | | |
| Desmodur N 36000 | 65 | 56° C. | 93% |
| Desmophen VP LS 2249/1, | | | |
| DBTL (0.01% by weight) | | | |
| Desmodur N 3600, | 79 | 54° C. | 93% |
| Desmophen XP 2488, | | | |
| DBTL (0.01% by weight) | | | |
| Desmodur N 3600, | 27 | 8° C. | 93% |
| Desmophen XP 2328, | | | |
| DBTL (0.01% by weight) | | | |

From the Comparative Examples revealed in Table 2 it is clear that when either the NCO functionality of the polyisocyanate component is ≦3 or the OH functionality of the polyol component is ≦3 or the OH content thereof is ≦25% by weight, it is not possible to obtain polyurethanes which simultaneously have high mechanical stability (Shore D), high thermal stability (Tg) and high transparency (transmittance).

1-15. (canceled)

16. A polyurethane exclusively composed of a polyisocyanate component and of a polyol component, where the polyisocyanate component consists of one or more polyisocyanates and the average NCO functionality per molecule of the polyisocyanate component is ≧3, and the polyol component consists of one or more polyols and the average OH functionality per molecule of the polyol component is ≧3 and its OH content is ≧25% by weight.

17. The polyurethane according to claim 16, wherein the average NCO functionality per molecule of the polyisocyanate component is ≦4 and/or the average OH functionality per molecule of the polyol component is ≦6.

18. The polyurethane according to claim 16, wherein the polyisocyanate component consists exclusively of aliphatic polyisocyanates.

19. The polyurethane according to claim 16, wherein the NCO content of the polyisocyanate component is ≧15% by weight and ≦55% by weight.

20. The polyurethane according to claim 16, wherein at least one polyisocyanate is a biuret, a uretdione or a trimer of a di- or triisocyanate.

21. The polyurethane according to claim 20, wherein the di- or triisocyanate is selected from the group consisting of hexane diisocyanate, isophorone diisocyanate, diisocyanatodicyclohexylmethane, xylylene diisocyanate, tetramethylxylylene diisocyanate, trimethylhexane diisocyanate, hydrogenated xylylene diisocyanate, hydrogenated toluene diisocyanate, pentane diisocyanate, and 4-isocyanatomethyloctane 1,8-diisocyanate.

22. The polyurethane according to claim 16, wherein the OH content of the polyol component is ≧25% by weight and ≦60% by weight.

23. The polyurethane according to claim 16, wherein the molecular ratio of polyisocyanate to polyol is adjusted in such a way that the ratio of the NCO groups to OH groups is in the range from 0.95:1.00 to 1.20:1.00.

24. A process for the production of a polyurethane according to claim 16 comprising mixing the polyisocyanate component and the polyol component forming a mixture, optionally adding a catalyst and optionally heating the mixture.

25. The process according to claim 24, wherein, before mixing, the polyisocyanate component and the polyol component are heated to a temperature of from 30 to 90° C.

26. The process according to claim 24, wherein the quantity of catalyst added, based on sums of the masses of the polyisocyanate component and of the polyol component, is from 0.001 to 0.100% by weight.

27. The process according to claim 24, wherein the catalyst selected from amines and/or metal organyl compounds.

28. An optical element comprising the polyurethane according to claim 16.

29. The optical element according to claim 28, wherein the optical element is an optical conductor, an optical diffuser or a lens.

30. A method comprising conducting light, scattering light and/or deflecting light utilizing the polyurethane according to claim 16 for
